(19) United States
(12) Patent Application Publication
(10) Pub. No.: US 2023/0356292 A1
(43) Pub. Date: Nov. 9, 2023

(54) Water-Soluble Silicone-Based Release Agent

(71) Applicant: QUAKER CHEMICAL CORPORATION, Wilmington, DE (US)

(72) Inventors: Matthew LOCOCO, Centerville, OH (US); Chirag VAGHELA, Beavercreek, OH (US)

(73) Assignee: QUAKER CHEMICAL CORPORATION, Wilmington, DE (US)

(21) Appl. No.: 18/354,146

(22) Filed: Jul. 18, 2023

Related U.S. Application Data
(63) Continuation of application No. 17/319,593, filed on May 13, 2021.
(60) Provisional application No. 63/024,737, filed on May 14, 2020.

(51) Int. Cl. B22D 17/22; C08L 83/12; B22D 17/20

(52) U.S. Cl. CPC B22D 17/2209; C08L 83/12; B22D 17/2007; C08L 2201/54

(57) ABSTRACT

A release agent includes a water-soluble silicone polymer and method for lubricating a die casting mold includes applying a release agent to an inner surface of the mold and injecting a molten metal into the mold, wherein the release agent includes a water-soluble silicone polymer.

### CROSS-REFERENCE TO RELATED APPLICATIONS

This application claims the benefit of U.S. Provisional Patent Application No. 63/024,737 filed May 14, 2020 entitled “Water-Soluble Silicone-Based Release Agent” which is incorporated by reference herein in its entirety.

### BACKGROUND OF THE INVENTION

The present invention generally relates to die lubrication for use in mold and casting operations and, more particularly, to a water-soluble silicone based release agent for use in high pressure die casting.

High pressure die casting (“HPDC”) is a well-known process in which molten metal is forced under high pressure and heat into a cavity of a die casting mold. The molten metal solidifies while in the mold cavity, forming a cast part having the shape of the mold cavity. After the cast part is formed, it is then ejected from the mold cavity.

While solidifying in the mold cavity, the molten metal can adhere to the surfaces of the mold cavity. This can result in damage to the cast part or the mold parts. To help avoid these problems, die casting release agents have been used to help ensure proper removal of the cast part from the mold cavity.

The HPDC market predominantly uses silicone in water emulsions as a major component in die casting release agents. These materials are the most efficient at producing quality castings with minimum adverse process effects. However, secondary processes like chrome plating, painting, powder coating and adhesives all suffer from the use of the paintable silicone oils. Paintable silicone oils, if left on the surface of the cast part, will cause issues with all of the secondary processes mentioned above. Moreover, traditional silicone in water emulsions utilize a hydrophobic silicone and a surfactant or emulsifier to emulsify the silicone in water. The use of such low molecular weight surfactants or emulsifiers leads to increased porosity in casting operations where the release agent becomes trapped in the molten metal during the casting process. There is a need for a release agent that is more friendly to secondary processing of the casting parts.

### BRIEF SUMMARY OF THE INVENTION

In some embodiments a release agent includes a water-soluble polymer, which includes a silicone polymer and a hydrophilic substituent. The hydrophilic substituent may include a hydrophilic polymer. In some embodiments the hydrophilic polymer may include a polyalkylene glycol, such as a polyethylene glycol or a polypropylene glycol. In some embodiments the silicone polymer is linear, while in other embodiments the silicone polymer is branched. In some embodiments the water-soluble polymer has a molecular weight of about 2,500 Da to about 500,000 Da. In some embodiments the release agent is exclusive of surfactant. In some embodiments the release agent further comprises a polar solvent, for example water. In some embodiments the release agent is a microemulsion. In some embodiments the water and water-soluble polymer are present in a ratio of about 40:1 to about 200:1 by volume of the water and the water-soluble polymer. In some embodiments a release agent includes a water-soluble polymer and water, wherein the water-soluble polymer comprises a linear silicone polymer has a hydrophilic substituent and a molecular weight of about 2,500 Da to about 500,000 Da.

In some embodiments a method of preventing a die cast part from attaching to a mold includes applying a release agent comprising a water-soluble silicone polymer to an inner surface of the mold before injecting a molten material into the mold. In some embodiments applying comprises spraying or painting. A method of preventing a die cast part from attaching to a mold may further comprise diluting the release agent. In other embodiments a method of preventing a die cast part from attaching to a mold comprises applying the release agent neat, that is, substantially free of added solvent. A method of preventing a die cast part from attaching to a mold may further comprise allowing the molten material to cool to form a solid part.

In some embodiments a method of casting a part includes applying a release agent comprising a water-soluble silicone polymer to an inner surface of a mold; and injecting a molten metal into the mold. the water-soluble silicone polymer is a dimethicone copolymer, such as a polyethylene glycol or a polypropylene glycol. In some embodiments the dimethicone copolymer is branched, while in other embodiments the dimethicone copolymer is linear. The molten metal may be injected at a pressure of about 150 to about 6500 ton. In some embodiments the method may further include diluting the release agent with a solvent, such as water. The method may still further include cooling the molten metal to form a cast piece. In some embodiments the method further includes releasing the cast piece from the mold. In some embodiments of a method, the dimethicone copolymer is selected from the group consisting of Dimethicone PEG-8 Adipate, Dimethicone PEG-8 Benzoate, Dimethicone PEG-7 Phosphate, Dimethicone PEG-10 Phosphate, Dimethicone PEG/PPG-20/23 Benzoate, Dimethicone PEG/PPG-7/4 Phosphate, Dimethicone PEG/PPG-12/4 Phosphate, PEG-3 Dimethicone, PEG-7 Dimethicone, PEG-8 Dimethicone, PEG-9 Dimethicone, PEG-10 Dimethicone, PEG-12 Dimethicone, PEG-14 Dimethicone, PEG-17 Dimethicone, PEG/PPG-3/10 Dimethicone, PEG/PPG-4/12 Dimethicone, PEG/PPG-6/11 Dimethicone, PEG/PPG-8/14 Dimethicone, PEG/PPG-14/4 Dimethicone, PEG/PPG-15/15 Dimethicone, PEG/PPG-16/2 Dimethicone, PEG/PPG-17/18 Dimethicone, PEG/PPG-18/18 Dimethicone, PEG/PPG-19/19 Dimethicone, PEG/PPG-20/6 Dimethicone, PEG/PPG-20/15 Dimethicone, PEG/PPG-20/20 Dimethicone, PEG/PPG-20/23 Dimethicone, PEG/PPG-20/29 Dimethicone, PEG/PPG-22/23 Dimethicone, PEG/PPG-22/24 Dimethicone, PEG/PPG-23/6 Dimethicone, PEG/PPG-25/25 Dimethicone and PEG/PPG-27/27 Dimethicone and combinations thereof.

### DETAILED DESCRIPTION OF THE INVENTION

The present invention provides release agents useful in die casting, and in particular, high pressure die casting, operations. In some embodiments a release agent comprises a water-soluble silicone. In some embodiments the release agent further includes a solvent. In some embodiments the release agent is exclusive of surfactant.

Release agents of the present invention comprising a water soluble silicone are easier to clean from a cast part surface post-casting than traditional release agents and hence are better for secondary processing (e.g., chrome plating, painting, powder coating, adhesive coating, etc.). Traditional release agents require a surfactant or other emulsifier to formulate a silicone oil with water, and present concerns over stability of the resulting emulsion. Moreover, the use of a surfactant can lead to increased porosity in casting operations where release agent is trapped in the molten material during the casting process. Release agents of the present invention comprising a water soluble silicone are water soluble and accordingly, provide the added benefit of not requiring a surfactant to formulate with water. The use of water-soluble silicone polymers in the release agents of the present invention also enhances the ability to recycle the release agent as unused material will dissolve readily in water and can be applied repeatedly.

In some embodiments a release agent has sufficient thermal stability to withstand molten alloy temperatures for magnesium, aluminum, zinc and/or lead castings.

Water Soluble Silicone

Release agents of the present invention may include a water-soluble silicone. Any silicone polymer modified with one or more hydrophilic substituents so that the material is water soluble is included within the scope of the invention. In the present invention, a “water-soluble” silicone compound means that the silicone compound has a solubility in water at 25° C. of at least 0.01 g/100 g water, at least 0.05 g/100 g water, at least 0.1 g/100 g water, or at least 0.2 g/100 g water. Examples of water-soluble silicones include dimethicone copolyols, amodimethicone copolyols, and quaternized silicones.

In some embodiments the hydrophilic substituent is a polyalkylene glycol, preferably polyethylene glycol or polypropylene glycol.

In some embodiments the water soluble silicone is a linear copolymer of silicone and ethylene/propylene oxide. In other embodiments the water soluble silicone is a branched silicone polymer with ethylene oxide or propylene oxide branches.

In some embodiments the water-soluble silicone is a linear dimethicone copolyol as shown in formula I:

(SiR¹₃)—O—(SiR²₂—O—)ₓ—(SiR₂PE-O—)_{y}—(SiR¹₃) Formula I:

In some embodiments, the water-soluble silicone is a linear dimethicone copolyol as shown in formula II:

PE-(SiR¹₂)—O—(SiR²₂—O—)ₓ—(SiR¹₂)-PE Formula II:

In some embodiments, the water-soluble silicone is a branched dimethicone copolyol as shown in formula III:

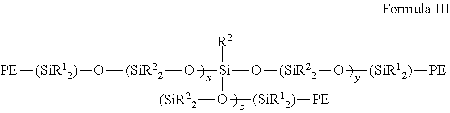

In some embodiments, the water-soluble silicone is a branched dimethicone copolyol as shown in formula IV:

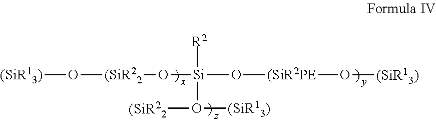

In Formulas I-IV, the residues R1 and R2 mutually independently denote hydrogen, a methyl residue, a C2 to C30 linear or cyclic, saturated or unsaturated, substituted or unsubstituted hydrocarbon residue, and/or an aryl residue. Non-limiting examples of the residues represented by R1 and R2 include alkyl residues, such as methyl, ethyl, propyl, isopropyl, butyl, isobutyl, pentyl, isopentyl, neopentyl, amyl, isoamyl, hexyl, isohexyl, lauryl, stearyl, behenyl, and the like; alkenyl residues, such as vinyl, halovinyl, alkylvinyl, allyl, haloallyl, alkylallyl; cycloalkyl residues, such as cyclobutyl, cyclopentyl, cyclohexyl and the like; aryl residues, such as phenyl residues and benzyl residues. Any of the foregoing examples may optionally be substituted with one or more 0, S, and N.

In Formulas I-IV, PE denotes a polyoxyalkylene residue, preferably polyethylene ether or polypropylene ether.

In Formulas I-IV, the numbers x, y and z are integers running mutually independently, where x is from about 18 to about 180, y is from about 18 to about 180, and z is from about 5 to about 20

In general, silicones designated by an INCI name beginning with “PEG” or “PPG” are suitable for use in release agents of the present invention. Examples of suitable water-soluble dimethicone copolyols include, but are not limited to, Dimethicone PEG-8 Adipate, Dimethicone PEG-8 Benzoate, Dimethicone PEG-7 Phosphate, Dimethicone PEG-10 Phosphate, Dimethicone PEG/PPG-20/23 Benzoate, Dimethicone PEG/PPG-7/4 Phosphate, Dimethicone PEG/PPG-12/4 Phosphate, PEG-3 Dimethicone, PEG-7 Dimethicone, PEG-8 Dimethicone, PEG-9 Dimethicone, PEG-10 Dimethicone, PEG-12 Dimethicone, PEG-14 Dimethicone, PEG-17 Dimethicone, PEG/PPG-3/10 Dimethicone, PEG/PPG-4/12 Dimethicone, PEG/PPG-6/11 Dimethicone, PEG/PPG-8/14 Dimethicone, PEG/PPG-14/4 Dimethicone, PEG/PPG-15/15 Dimethicone, PEG/PPG-16/2 Dimethicone, PEG/PPG-17/18 Dimethicone, PEG/PPG-18/18 Dimethicone, PEG/PPG-19/19 Dimethicone, PEG/PPG-20/6 Dimethicone, PEG/PPG-20/15 Dimethicone, PEG/PPG-20/20 Dimethicone, PEG/PPG-20/23 Dimethicone, PEG/PPG-20/29 Dimethicone, PEG/PPG-22/23 Dimethicone, PEG/PPG-22/24 Dimethicone, PEG/PPG-23/6 Dimethicone, PEG/PPG-25/25 Dimethicone and PEG/PPG-27/27 Dimethicone.

In some embodiments a water-soluble silicone polymer has sufficient thermal stability to withstand molten alloy temperatures, for example, molten alloy temperatures for magnesium, aluminum, zinc and/or lead castings.

In some embodiments a water soluble silicone is an amine-functionalized silicone (“amodimethicone”) copolyol. An example of an amodimethicone copolyol is PEG-7 amodimethicone.

In some embodiments a water soluble silicone is a quaternized silicone.

Solvent

Release agents of the present invention may include a solvent. In some embodiments the release agent includes water. In some embodiments the release agent includes a polar solvent. Polar solvents that may be used in release agents of the invention include, but are not limited to, water, acetic acid, methanol, ethanol, n-propanol, n-butanol, acetone, ethyl acetate, dimethyl sulfoxide, acetonitrile, and dimethylformamide. In some embodiments a release agent includes a hydrocarbon solvent. Hydrocarbon solvents include, but are not limited to, ligroin, kerosene, and other low viscosity hydrocarbons. The release agent may be in the form of a solution, a microemulsion, an emulsion, or other mixture.

Release agents may be provided as a concentrate, wherein the water-soluble silicone is about 50% to about 99%, about 60% to about 99%, about 70% to about 99%, about 75% to about 95%, about 80 to about 95%, about 85% to about 95%, about 90% to about 95%, about 90% to about 99%, or about 95% to about 99% by weight of the release agent composition.

In some embodiments the concentrate can be diluted so that the release agent composition includes water-soluble silicone in an amount of about 0.2 to about 100 wt % of the release agent composition. A release agent concentrate can be diluted with water or other hydrophilic solvent, or in some embodiments, a hydrocarbon solvent. Typically, the release agent concentrate will be diluted with solvent, such as upon application, for example in an amount of about 1:100, about 1:90, about 1:80, about 1:70, about 1:60, about 1:50, about 1:40, about 1:30, about 1:20, about 1:10, about 1:1, about 10:1, about 20:1, about 30:1, about 40:1, about 50:1, about 60:1, about 70:1, about 75:1, about 80:1, about 90:1, or about 100:1 parts solvent to release agent concentrate.

In some embodiments the release agent composition has a viscosity of about 0.5 cps to about 1000 cps, about 0.9 cps to about 1000 cps, about 100 cps to about 1000 cps, or about 300 to 900 cps. In some embodiments, the release agent composition is a concentrate that can be diluted to a composition having a viscosity of about 0.9 to about 900 cps, about 0.9 to about 700 cps, about 0.9 to about 500 cps, about 0.9 to about 300 cps, about 0.9 to about 100 cps, about 0.9 to about 50 cps, about 0.9 to about 25 cps, about 0.9 to about 10 cps, or about 0.9 to about 5 cps before use.

Other Components

In some embodiments a release agent composition comprises a water-soluble silicone. In some embodiments a release agent composition comprises a water-soluble silicone and a solvent. In some embodiments a release agent composition consists essentially of a water-soluble silicone and a solvent. In some embodiments a release agent composition is exclusive of a surfactant. In some embodiments a release agent composition is exclusive of an emulsifier. In some embodiments a release agent composition is exclusive of a surfactant and an emulsifier.

Release agent compositions of the present invention may include one or more additives, though inclusion of any additives is optional. In some embodiments a release agent composition comprises one or more of anti-wear additives, antioxidants, anti-foam additives, corrosion inhibitors, biocides, and extreme pressure additives. In some embodiments additives total about 0.1 to about 3 wt. % of the release agent composition. In some embodiments additives are each present at about 0.1 to about 3 wt. % of the release agent composition. In some embodiments a release agent composition is exclusive of additives and consists essentially of a water-soluble silicone polymer and a solvent.

Method

The present invention provides methods for releasing a part from a mold or cast, which include applying a release agent as described herein to an inner surface of the mold or cast and injecting a fluid material into the mold or cast. The method may further include applying gas under pressure to the fluid material in the mold or cast. The method may further include allowing the fluid material to set to a solid form, and releasing the solid form from the mold or cast.

Any type of mold or cast useful for forming parts can be used with the methods of the invention. In particular, foam injection molds, plastic molds, die cast molds, and high pressure die cast molds are suitable for use in the present methods. The present methods are particularly well suited for high pressure die cast molds.

The release agent may comprise a water-soluble silicone as disclosed herein. In particular, the release agent may comprise a branched or linear dimethicone copolyol comprising (i.e., substituted with) a polyakylene glycol, such as polyethylene glycol and/or polypropylene glycol. For example, the release agent may comprise Dimethicone PEG-8 Adipate, Dimethicone PEG-8 Benzoate, Dimethicone PEG-7 Phosphate, Dimethicone PEG-10 Phosphate, Dimethicone PEG/PPG-20/23 Benzoate, Dimethicone PEG/PPG-7/4 Phosphate, Dimethicone PEG/PPG-12/4 Phosphate, PEG-3 Dimethicone, PEG-7 Dimethicone, PEG-8 Dimethicone, PEG-9 Dimethicone, PEG-10 Dimethicone, PEG-12 Dimethicone, PEG-14 Dimethicone, PEG-17 Dimethicone, PEG/PPG-3/10 Dimethicone, PEG/PPG-4/12 Dimethicone, PEG/PPG-6/11 Dimethicone, PEG/PPG-8/14 Dimethicone, PEG/PPG-14/4 Dimethicone, PEG/PPG-15/15 Dimethicone, PEG/PPG-16/2 Dimethicone, PEG/PPG-17/18 Dimethicone, PEG/PPG-18/18 Dimethicone, PEG/PPG-19/19 Dimethicone, PEG/PPG-20/6 Dimethicone, PEG/PPG-20/15 Dimethicone, PEG/PPG-20/20 Dimethicone, PEG/PPG-20/23 Dimethicone, PEG/PPG-20/29 Dimethicone, PEG/PPG-22/23 Dimethicone, PEG/PPG-22/24 Dimethicone, PEG/PPG-23/6 Dimethicone, PEG/PPG-25/25 Dimethicone and PEG/PPG-27/27 Dimethicone and combinations thereof.

The release agent can be applied to the mold or cast by any traditional method, including electrospray application, pulse application, brush application, roller application, pouring, or spraying. Preferably, the release agent may be applied to the mold or cast by spraying. In some embodiments the release agent is applied at high pressure, e.g., about 60 to about 80 psi, about 60 to about 100 psi, about 60 to about 150 psi, about 60 psi to about 200 psi, about 100 psi to about 750 psi, about 200 to about 600 psi, about 300 to 500 psi, or about 400 to about 600 psi. In some embodiments the release agent is applied at low pressure, e.g., about 10 psi.

In some embodiments the release agent composition is combined with an antisolder paste or a start-up lubricant. In some embodiments the release agent can be used as a plunger lubricant.

In some embodiments the release agent is sprayed together with a solvent to dilute the release agent from a concentrate to a final composition. The solvent may be a polar solvent and is preferably water. In some embodiments the release agent is diluted with solvent (e.g., water) in a range of about 10:1 to about 400:1 parts by volume solvent to release agent, about 10:1 to about 200:1 parts by volume, about 25:1 to about 150:1 parts by volume solvent to release agent, or about 50:1 to about 100:1 parts by volume solvent to release agent at application.

The fluid material is typically a molten metal or metal alloy, for example without limitation a fluid material can be aluminum, magnesium, zinc, lead or brass.

In some embodiments the fluid material is injected under high pressure. Such high pressure may be in the range of about 150 ton to about 6500 ton. In some embodiments a gas is applied under high pressure to the fluid material to push the fluid material into the die. In some embodiments a gas is applied to the fluid material to sparge the fluid material (e.g. metal). Such gas may be, for example, nitrogen.

In some embodiments the cast or mold is opened to expose the solid form or part. The solid form or part can be released from the cast or mold.

It will be appreciated by those skilled in the art that changes could be made to the exemplary embodiments shown and described above without departing from the broad inventive concepts thereof. It is understood, therefore, that this invention is not limited to the exemplary embodiments shown and described, but it is intended to cover modifications within the spirit and scope of the present invention as defined by the claims. For example, specific features of the exemplary embodiments may or may not be part of the claimed invention and various features of the disclosed embodiments may be combined. Unless specifically set forth herein, the terms “a”, “an” and “the” are not limited to one element but instead should be read as meaning “at least one”.

Further, to the extent that the methods of the present invention do not rely on the particular order of steps set forth herein, the particular order of the steps should not be construed as limitation on the claims. Any claims directed to the methods of the present invention should not be limited to the performance of their steps in the order written, and one skilled in the art can readily appreciate that the steps may be varied and still remain within the spirit and scope of the present invention.

1-12. (canceled)

13. A method of preventing a metal or metal alloy die cast part from attaching to a mold comprising:
applying a release agent comprising a water-soluble silicone polymer to an inner surface of the mold; and
injecting a molten metal or metal alloy material into the mold after applying the release agent to the inner surface of the mold.

14. The method according to claim 13, wherein applying comprises spraying, electrospraying, pulsing, brushing, rolling, pouring, or painting.

15. The method according to claim 13, further comprising diluting the release agent.

16. The method according to claim 13, further comprising allowing the molten metal or metal alloy material to cool to form a solid part; and
releasing the metal or metal alloy die case part from the mold.

17. A method of casting a metal or metal alloy part comprising:
applying a release agent comprising a water-soluble silicone polymer to an inner surface of a mold; and
injecting a molten metal or metal alloy into the mold.

18. The method of claim 17, further comprising diluting the release agent with a solvent.

19. The method of claim 18, wherein the solvent is water.

20. The method of claim 17, wherein the molten metal or metal alloy is injected at a pressure of about 150 to about 6500 ton.

21. The method of claim 17, further comprising cooling the molten metal or metal allot to form a cast metal or metal alloy part.

22. The method of claim 21, further comprising releasing the cast metal or metal alloy from the mold.

23. The method of claim 17, wherein the water-soluble silicone polymer is a dimethicone copolymer.

24. The method of claim 23, wherein the dimethicone copolymer comprises polyethylene glycol.

25. The method of claim 23, wherein the dimethicone copolymer comprises polypropylene glycol.

26. The method of claim 23, wherein the dimethicone copolymer is branched.

27. The method of claim 23, wherein the dimethicone copolymer is linear.

28. The method of claim 23, wherein the dimethicone copolymer is selected from the group consisting of Dimethicone PEG-8 Adipate, Dimethicone PEG-8 Benzoate, Dimethicone PEG-7 Phosphate, Dimethicone PEG-10 Phosphate, Dimethicone PEG/PPG-20/23 Benzoate, Dimethicone PEG/PPG-7/4 Phosphate, Dimethicone PEG/PPG-12/4 Phosphate, PEG-3 Dimethicone, PEG-7 Dimethicone, PEG-8 Dimethicone, PEG-9 Dimethicone, PEG-10 Dimethicone, PEG-12 Dimethicone, PEG-14 Dimethicone, PEG-17 Dimethicone, PEG/PPG-3/10 Dimethicone, PEG/PPG-4/12 Dimethicone, PEG/PPG-6/11 Dimethicone, PEG/PPG-8/14 Dimethicone, PEG/PPG-14/4 Dimethicone, PEG/PPG-15/15 Dimethicone, PEG/PPG-16/2 Dimethicone, PEG/PPG-17/18 Dimethicone, PEG/PPG-18/18 Dimethicone, PEG/PPG-19/19 Dimethicone, PEG/PPG-20/6 Dimethicone, PEG/PPG-20/15 Dimethicone, PEG/PPG-20/20 Dimethicone, PEG/PPG-20/23 Dimethicone, PEG/PPG-20/29 Dimethicone, PEG/PPG-22/23 Dimethicone, PEG/PPG-22/24 Dimethicone, PEG/PPG-23/6 Dimethicone, PEG/PPG-25/25 Dimethicone and PEG/PPG-27/27 Dimethicone and combinations thereof.

29. (canceled)

30. The method according to claim 17, wherein applying the release agent comprises spraying, electrospraying, pulsing, brushing, rolling, pouring, or painting.

31. The method according to claim 17, further comprising applying the release agent by spraying at a pressure from about 60 psi to about 200 psi.

32. The method according to claim 17, further comprising applying the release agent by spraying at a pressure from about 100 psi to about 750 psi.

33. The method according to claim 17, further comprising applying the release agent by spraying at a pressure of about 10 psi.
